(19) United States
(12) Patent Application Publication
(10) Pub. No.: US 2024/0088935 A1
(43) Pub. Date: Mar. 14, 2024

(54) 2G Over 4G RRH

(71) Applicant: Parallel Wireless, Inc., Nashua, NH (US)

(72) Inventors: Ofir Ben Ari Katzav, Zur Itshak (IL); Baruch Navon, Alumot (IL); Randy Rutherford, Bedford, NH (US); Ran Leviev, Yokneam Illit (IL); Keren Gertner Aleb, Kfar Sava (IL)

(21) Appl. No.: 18/460,531

(22) Filed: Sep. 1, 2023

Related U.S. Application Data
(60) Provisional application No. 63/403,271, filed on Sep. 1, 2022.

(51) Int. Cl. H04B 1/40

(52) U.S. Cl. CPC H04B 1/40; H04W 88/06

(57) ABSTRACT

Various embodiments of a radio frequency front end (RFFE) are disclosed, in one embodiment comprising: a 2G Global System for Mobile telecommunications (GSM) transceiver; a 4G Long Term Evolution (LTE) transceiver; and a combiner coupled to the 2G GSM transceiver and to the 4G LTE transceiver and to a radio head, coupled to the radio head via at least one stream of IQ samples, the at least one stream carrying samples derived from the 2G GSM transceiver and samples derived from the 4G LTE transceiver. The RFFE may be configured to provide downlink for 2G and 4G. The combiner may be configured to upsample 2G signals from the 2G GSM transceiver to a 4G carrier frequency. The RFFE may be configured to transmit both 2G and 4G on a same frequency band.

### CROSS-REFERENCE TO RELATED APPLICATIONS

The present application claims priority to, and incorporates by reference in its entirety, U.S. Prov. Pat. App. No. 63/403,271, having the same title as the present application and filed Sep. 1, 2022. This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety. Features and characteristics of and pertaining to the systems and methods described in the present disclosure, including details of the multi-RAT nodes and the gateway described herein, are provided in the documents incorporated by reference.

### BACKGROUND

2G or GSM is a highly desirable radio access technology (RAT) that is nevertheless not under active development. LTE is a common technology for which remote radio head (RRH) technology is mature. It is desirable to be able to transmit and receive GSM signals over LTE RRH while using LTE Fronthaul implementation, especially since in some cases GSM and LTE use similar frequency bands.

### SUMMARY

Various embodiments of a radio frequency front end (RFFE) are disclosed, in one embodiment comprising: a 2G Global System for Mobile telecommunications (GSM) transceiver; a 4G Long Term Evolution (LTE) transceiver; and a combiner coupled to the 2G GSM transceiver and to the 4G LTE transceiver and to a radio head, The combiner may be coupled to the radio head via at least one stream of IQ samples, the at least one stream carrying samples derived from the 2G GSM transceiver and samples derived from the 4G LTE transceiver. The RFFE may be configured to provide downlink for 2G and 4G. The combiner may be configured to upsample 2G signals from the 2G GSM transceiver to a 4G carrier frequency. The RFFE may be configured to transmit both 2G and 4G on a same frequency band. The RFFE may be configured to transmit both 2G and 4G on one or both of a 850 MHz frequency band or a 1900 MHz frequency band. The RFFE may be an uplink RFFE, and the combiner may provide demultiplexing of received 2G GSM signals from 2G GSM UEs and received 4G LTE signals from 4G LTE UEs. The RFFE may output 2G GSM samples to the 2G GSM transceiver and 4G LTE samples to the 4G LTE transceiver. The at least one stream may use one of a common public radio interface (CPRI) interface or an enhanced common public radio interface (eCPRI) interface. The RFFE may further comprise a 5G New Radio (NR) transceiver coupled to the combiner, and the combiner may be coupled to the radio head via at least one stream of IQ samples carrying samples derived from the 2G GSM transceiver and samples derived from the 5G NR transceiver. The radio head may output both 2G and 4G downlink on a single frequency carrier, in some embodiments.

In another embodiment, a method for providing 2G and 4G downlink on a single frequency carrier is disclosed, comprising: providing a 2G Global System for Mobile telecommunications (GSM) transceiver chain; providing a 4G Long Term Evolution (LTE) transceiver chain; intermixing samples of 2G and 4G at a digital radio frequency front end into a single intermixed sample stream; upsampling the intermixed sample stream to a carrier frequency compatible with both 2G and 4G; and transmitting the upsampled intermixed sample stream. The method may further comprise transmitting both 2G and 4G on a same carrier frequency. The method may further comprise using one of a common public radio interface (CPRI) interface or an enhanced common public radio interface (eCPRI) interface.

### BRIEF DESCRIPTION OF THE DRAWINGS

FIG. 1 depicts a 2G uplink chain, in accordance with some embodiments.

FIG. 2 depicts a 2G downlink chain, in accordance with some embodiments.

FIG. 3 depicts a 2G-capable multi-antenna, multi-carrier radio frequency front end (RFFE), in accordance with some embodiments.

FIG. 4 depicts an algorithm for combining 2G samples and 4G samples, in accordance with some embodiments.

FIG. 5 schematically depicts the use of timing advance for both 2G and 4G, in accordance with some embodiments.

FIG. 6 is a diagram showing different split options, in accordance with some embodiments.

FIG. 7 is a diagram showing different split options and the processing blocks they include, in accordance with some embodiments.

FIGS. 8 and 9 show split option 8, in accordance with some embodiments.

FIGS. 10 and 11 show split option 7.1, in accordance with some embodiments.

FIGS. 12 and 13 show split option 7.2, in accordance with some embodiments.

FIG. 13 shows split option 7.3, in accordance with some embodiments.

FIG. 14 shows split option 6, in accordance with some embodiments.

### DETAILED DESCRIPTION

Although prior publications talk about transferring a time domain generated signal (e.g. 2G) to frequency domain and about aggregating LTE and non-OFDM signals in such method it's not presenting the same concept as the present application. Meaning, there is no direct suggestion to present 2G/3G signals over LTE/5G DU/RRH. Moreover, it doesn't handle the split options discussed in our work. In our work we explain how transmission/reception of 2G/3G is possible with LTE/5G DU/RRH in V-RAN architecture and not how to multiplex them independently. Additionally, the inventors have contemplated switching a 2G/3G signal to frequency domain and then use 4G transmitter/receiver to transmit the signal correctly—this method is one of our suggestion to enable 2G/3G over LTE radio—this method was not specifically mentioned in the patent, e.g., combining of LTE signal (mentioned as OFDM signal), with non-OFDM signal (like 2G/3G).

The following capabilities are present:

Up sample OVS8->15.36 MHz in the DL and 15.36 MHz->OVS8 in the UL

NCO

Combine 4 carriers into 1 carrier

MRC/IRC clock

FH adaptive layer

As well as

Down sampling in the UL path 8->4

DC cancelation

Multi RAT (2G/3G/4G) RRH requirement

In typical RRHs, the RRH supports a single MAC Address interface with FH. This is expanded in some embodiments to provide a separate virtual MAC address per RAT, which enables directly addressing a 2G carrier and a 4G carrier separately.

While in the LTE Case (even with a 4G+4G case) the RRH communicated with a single FH Virtual function on a multi RAT Case, separate FH Virtual function is desirable.

These are the typical O-RAN FH planes.

Control Plane (C-Plane): Messages define the scheduling, coordination needed for transferring data, including aspects of beamforming for 5G. This includes scheduling and beamforming commands, DL precoding configurations, numerology, PRACH handling, etc.

User Plane (U-Plane): Messages for efficient data transfer, incl. Data compression; IQ data transfer procedures; and DL data precoding etc.

Sync Plane (S-Plane): Addresses the timing and synchronization aspects between the DU and RU, inc., synchronization topologies, PTP, Sync-E profile, time and frequency sync guidelines, etc.

Management Plane (M-plane): Defines the messages to manage the radio unit, incl. IP addresses for the layers, delay management, etc.

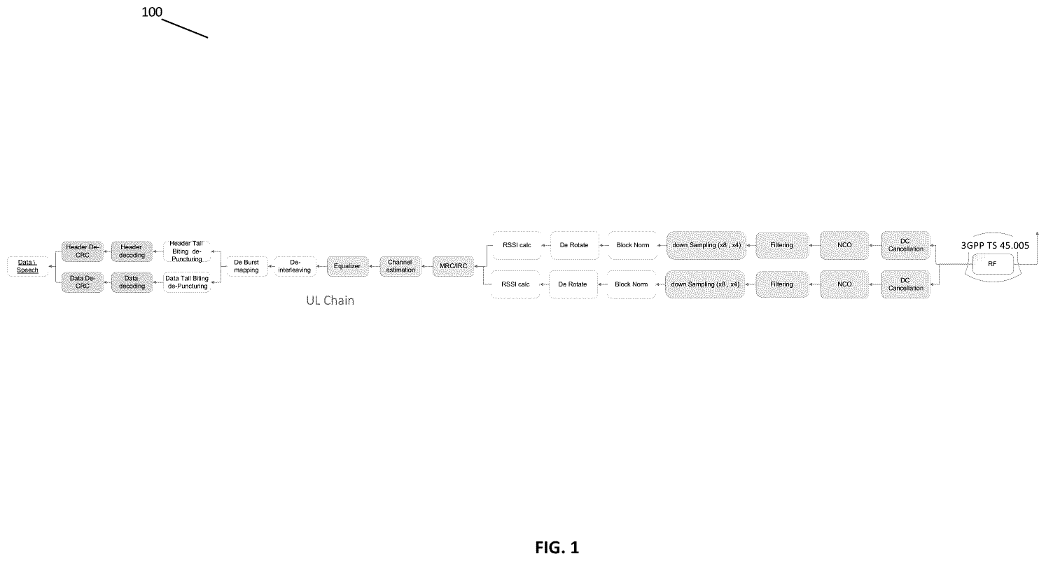

FIG. 1 depicts a 2G uplink chain, in accordance with some embodiments. The following radio frequency functions are performed sequentially, in some embodiments, starting with receiving signals from a 2G UE according to 3GPP TS 45.005 (GSM), hereby incorporated by reference. The RF signals are received and sampled into digital signals. DC cancellation, NCO, filtering, downsampling (×8, ×4), block normalization, derotation, RSSI calculation is performed along two paths. Continuing on, maximum/ratio combining/interference rejection combining (MRC/IRC) is performed on the combined data, followed by channel estimation, equalizer, de-interleaving, de-burst mapping is performed on the data, after which header and data are separated for tail de-biting/de-puncturing, decoding, and CRC. The header and data are then passed to a higher layer. In some embodiments, other functions may also be present.

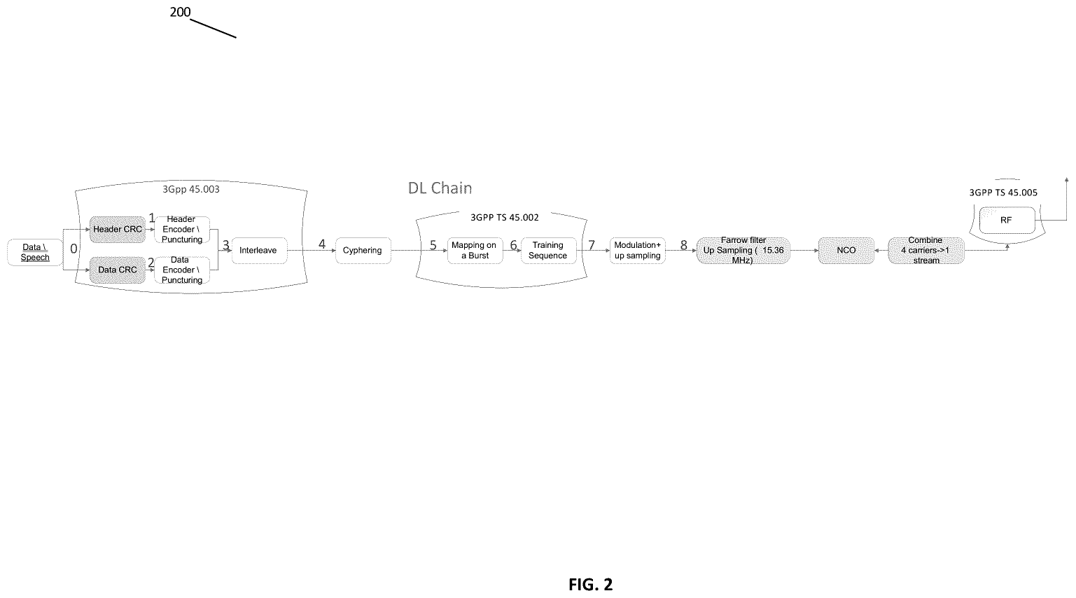

FIG. 2 depicts a 2G downlink chain, in accordance with some embodiments. The following radio frequency functions are performed sequentially, in some embodiments, starting with data and/or speech being passed along to the downlink from a higher layer. In accordance with 3GPP TS 45.003 (GSM), hereby incorporated by reference, header/data CRC, encoder/puncturing being performed. Header and data are interleaved. Ciphering is performed. Following, in accordance with 3GPP TS 45.002 (GSM), hereby incorporated by reference, mapping is performed on a burst and adding a training sequence, if needed. Next, modulation and upsampling is performed, and then upsampling with a farrow filter, to 15.36 MHz is performed. Mixing with a numerical controlled oscillator (NCO) to raise from baseband to transmit band, and four carriers are combined into one stream, and then sent to the 3GPP TS 45.005-compliant RF layer to be transmitted. In some embodiments, other functions may also be present.

The RRH supports the following options:

For S-plane, a broadcast can be applied across RATs—act as a single synchronization to all RAT.

For U-plane, each Carrier would come with a different MAC address, one for 2G (and 3G) And one for 4G and for any other RAT.

In some embodiments FH supports a separate virtual function per RAT, and as a result, FH works with different MAC addresses to each RAT to identify when the frame is 2G/3G/4G and will enable the adaptive layer both for DL and UL.

DC cancelation

RFMgr Requirements

For 2G, 10 MHz span of 2G ARFCN is desirable around the RRH central frequency.

However, the RRH may perform a DC Cancellation at the central Frequency of the antenna. As a result, the 2G UL ARFCN uses the following techniques to allow UL at or around the RRH Central frequency.

DC cancellation can be disabled per RAT or per carrier so some or all ARFCN can UL at center freq, in some embodiments. In other embodiments, we define specific freq around central frequency where the 2G cannot UL.

In some embodiments a bit-exact DSP can be used for the DC cancelation and down sampling 8->4.

Carrier Separation per antenna

In some embodiments, a L1 supports up to 4 TRX and spread it across 2 LTE Carriers i.e. 2 antennas, with 2G and 4G. Support for 4 antenna separation or more antennas is also supported.

All different combination of TRX separation per antenna is supported by FH and RRH. L1 performs the following steps:

The carrier configuration per antenna can be shared from the RF Mgr—since there is no RF Mgr interface with Phy, a dedicated API With Stack can be used to get RGMgr info through OAMMgr.

Logic of Carrier combining meaning FH sends a combined IQ TRX per antenna to RRH meaning the carrier contains the expected combination of TRX.

Each of the TRX is tagged with the antenna combination and sum in Phy with the rest of the TRX Aimed for that antenna.

FH adds under packet header the carrier (=antenna) of that IQ Frame.

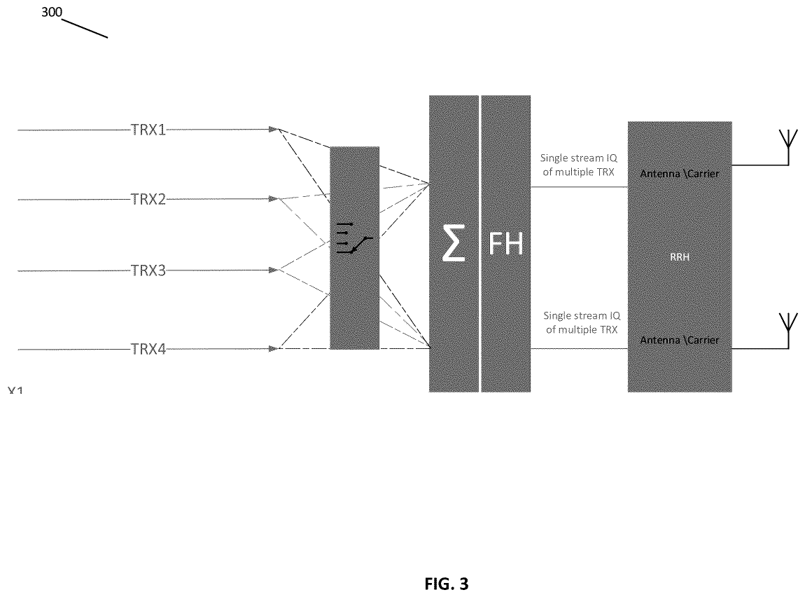

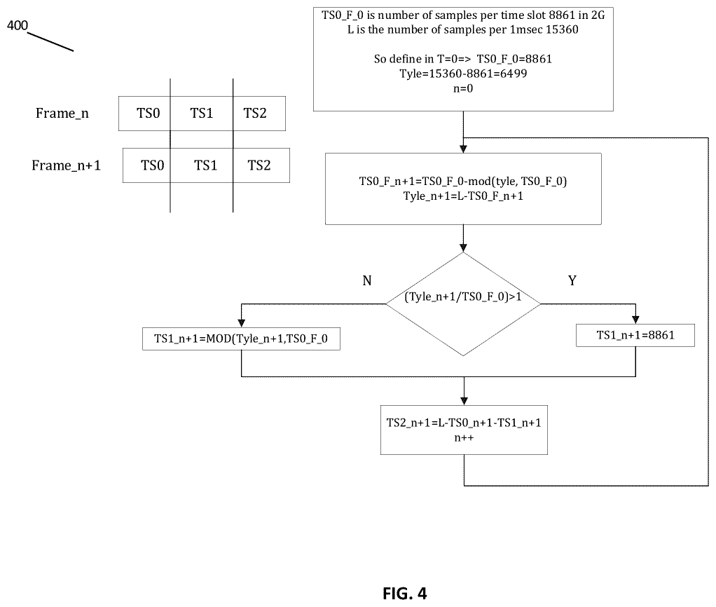

This is shown in FIG. 3. FIG. 3 depicts a 2G-capable multi-antenna, multi-carrier radio frequency front end (RFFE), in accordance with some embodiments. Four transceivers (TRX1, TRX2, TRX3, TRX4) are shown, coupled to an RF switch, the RF switch being capable of two outputs, as shown, or fewer or more in some embodiments. The RF switch is coupled to a combiner that combines all the elements fed into it. The combiner is coupled to an RF fronthaul, which spreads the TRX across, as shown, two outputs. This number of outputs may be fewer or more, in some embodiments. The combiner is able to combine 2G and 4G outputs using the method described herein, in accordance with some embodiments. The outputs are single streams of IQ sample data, that has been combined upstream from the multiple TRXes. Each stream of IQ data feeds an antenna or carrier that is provided by a RRH. The streams of IQ data may, in some embodiments, be carried by a CPRI or eCPRI fiber connection. In some embodiments, other functions may also be present.

For MRC/IRC feature in the uplink, in some embodiments, the IQ samples arrive at the same time to DSP processing and 2 antenna IQ Samples should be available for L1 once the UL Chain is triggered for processing (FH has ring buffer for each antenna separately). Support for up to 4 antennas is provided.

FH adaptation layer

FIG. 4 depicts an algorithm for combining 2G samples and 4G samples, in accordance with some embodiments.

The 2G FH approach is to use an existing LTE FH to convey a 2G upsampled IQ sample to/from the RRH, taking 2G on the baseband and doing the resampling so converting from GSM sample rate to 4G sample rate. This allows the 2G signal to be sent across the FH interface using, for example, eCPRI. This is enabled using an adaptation layer (module, block) in the FH.

In LTE for 10 MHz BW the sample rate is 15.36 MHz, this is the configuration for 2G.

A single 2G time slot (TS) sampled at OSR 8 (2.1666 MHz) is equivalent to 1250 samples. Will be up sampled to meet LTE sampling rate resulting to 8861,538461 samples per TS in LTE sample rate.

$$1250 * \frac{2304}{325} = 8 , 861. 538461 samples per TS$$

In some embodiments, number of samples round to 8661 samples and base on algo team inputs will update FH adaptive layer diagram. the direction is to send a different integer number of samples per TS so that the total number of samples per period will follow

$$1250 * \frac{2304}{325} = 8 , 861. 538461 samples$$

exactly.

LTE FH Frame is a single LTE Subframe in the duration of 1 mSec. GSM TS Exact duration is defined as followed:

$$GSM TS = 156.25 * ( \frac{8 * 6}{13} ) = 576.923076923077 \frac{u S e c}{Time slot}$$

This means that in one LTE fame will pass less than 2 TS (1 msec/576usec=1.7 TS).

FH collects all data to a ring buffer and then arrange to the data into TS size of 8861.

FH will trigger the PHY after 2G frame

$$GSM Frame = 8 * GSM TS = 8 * 156.25 * ( \frac{8 * 6}{13} ) \sim 4.615 \frac{uSec}{Frame}$$

FH adaptation layer rearranges the Sub frame into a 2G time slot in the Phy buffer in this way:

At 10 MHz BW a single FH Frame will accommodate 15360 samples (4G Sub frame).

Let's define basic TS size as TS0_F0 and max accommodate length as L

TS0 F0=8861, L=15360, n=0

Meaning in frame n=0 will send

TS0 F0=8861 and tyle=15360−8861=6499=>less than one TS=>TS1 F0=6499

In the next Frame n+1

TS0 F[n+1]=TS0 F0−mod(tyle,TS0 F0)=>TS0 F1=8861−mod(6499, 8861)=2362

and tyle[n+1]=15360−2362=12998=>num of sample is higher than one TS=>TS1 F1=8861

TS2 F1=L−TS0 Fn+1−TS1 Fn+1=15360−2362−8861=4137

And so on. This is shown in FIG. 4.

FH frame synchronization Requirements between DL to UL

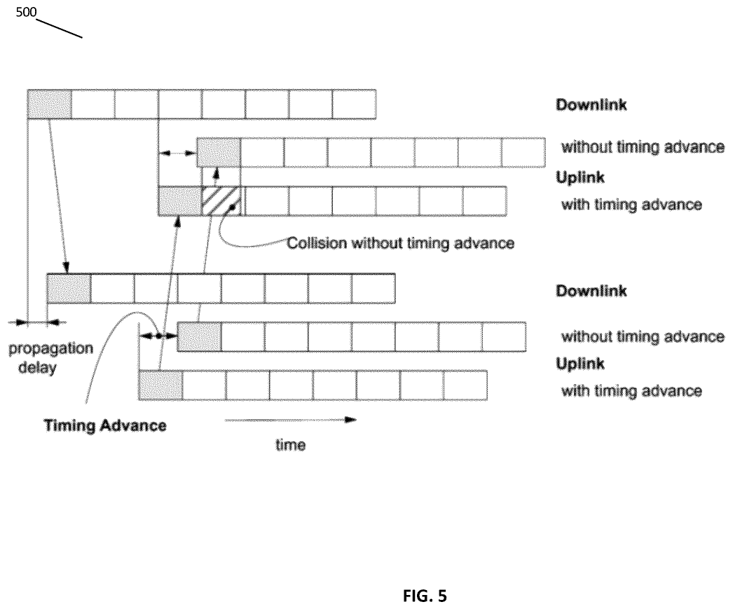

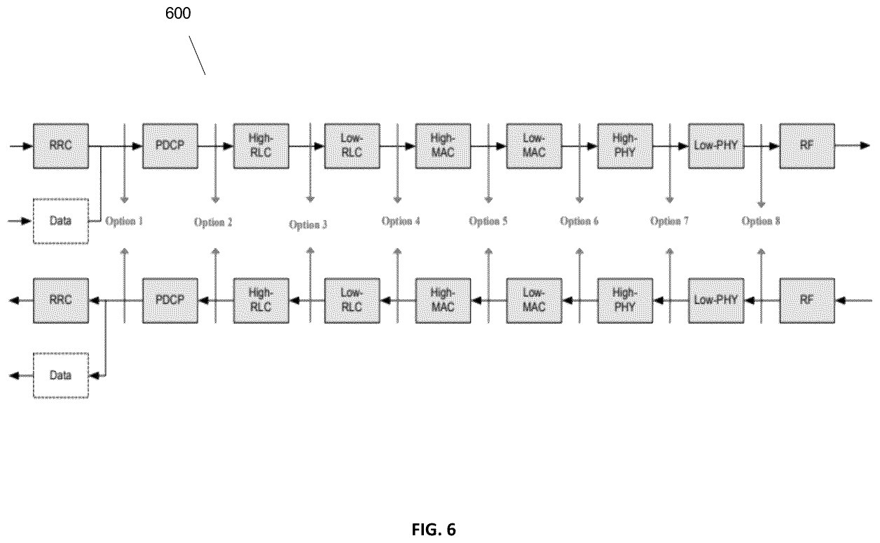

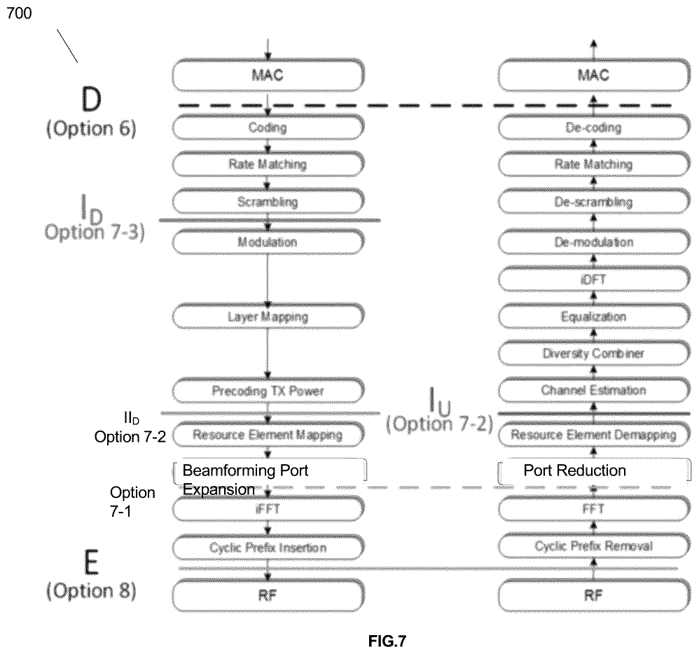

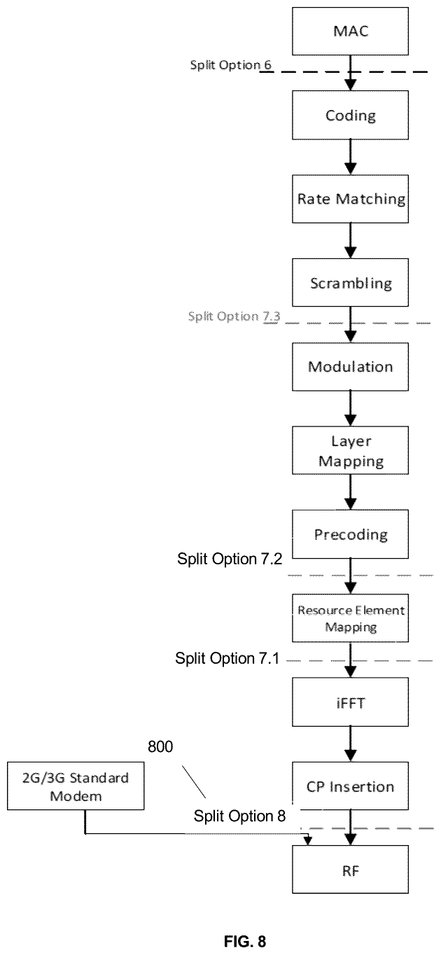

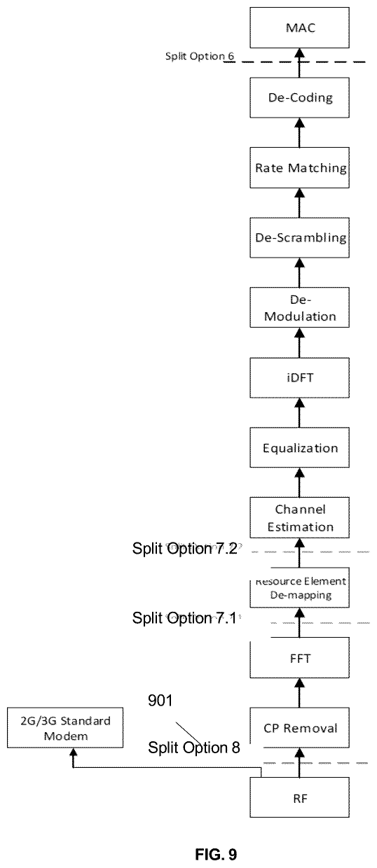

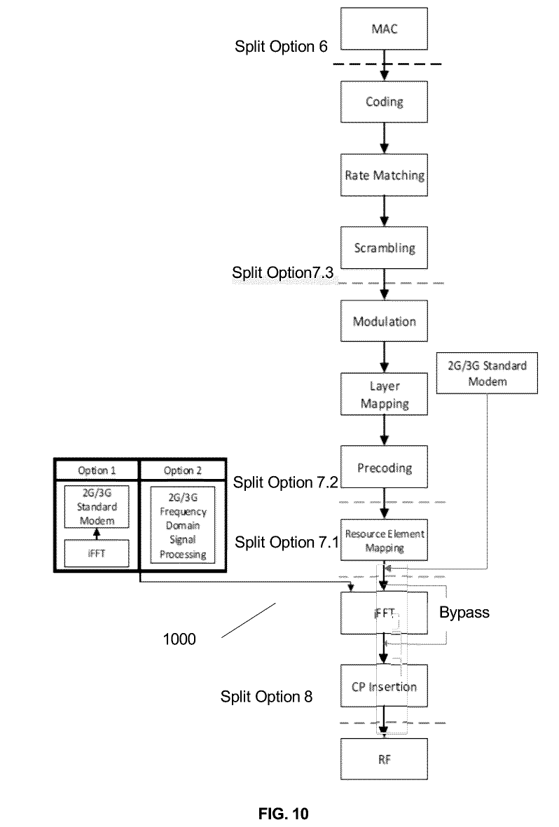

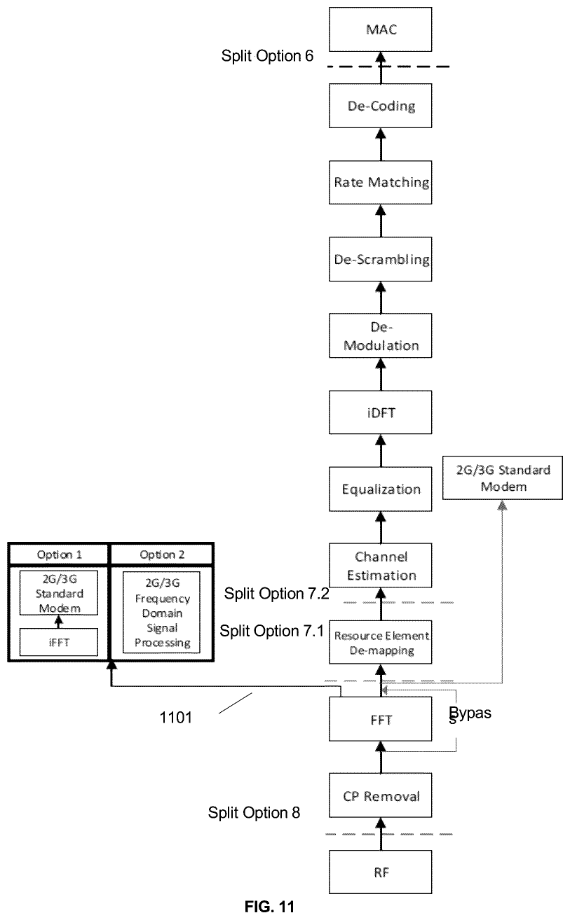

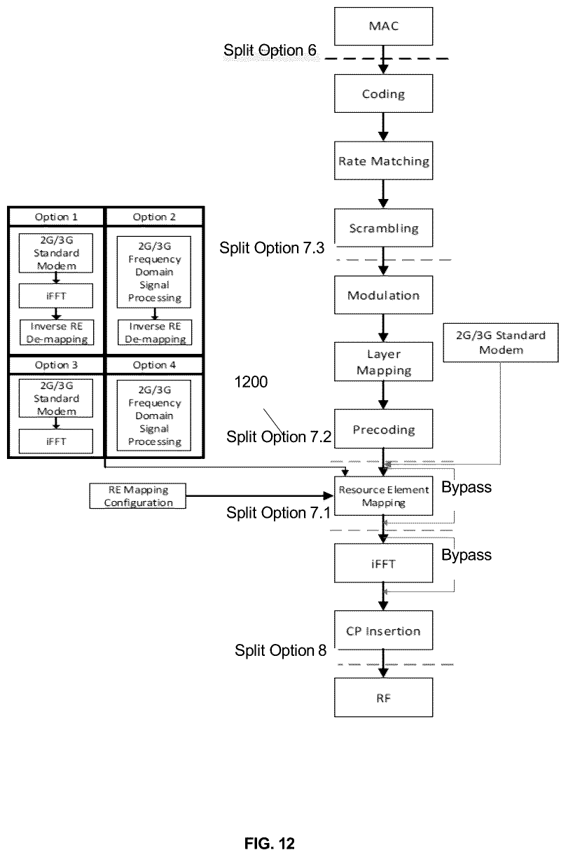

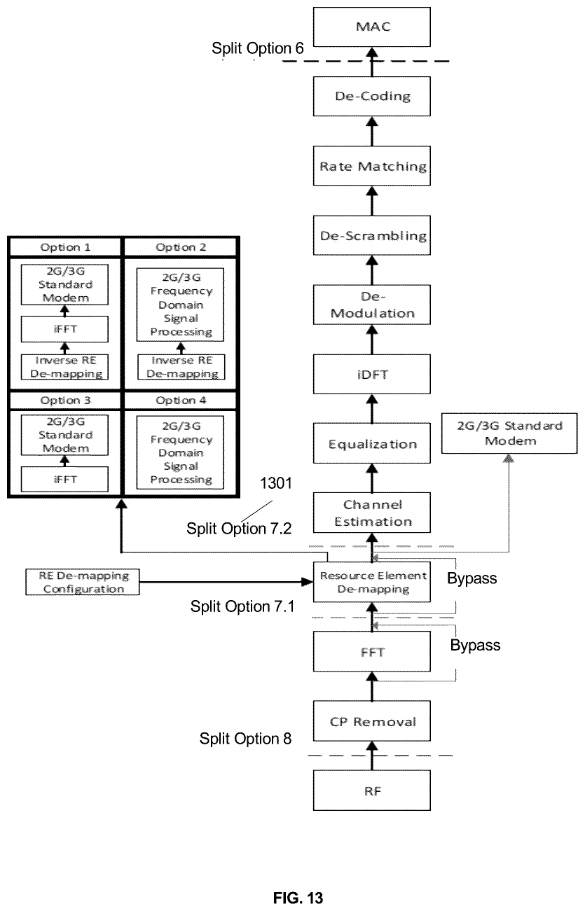

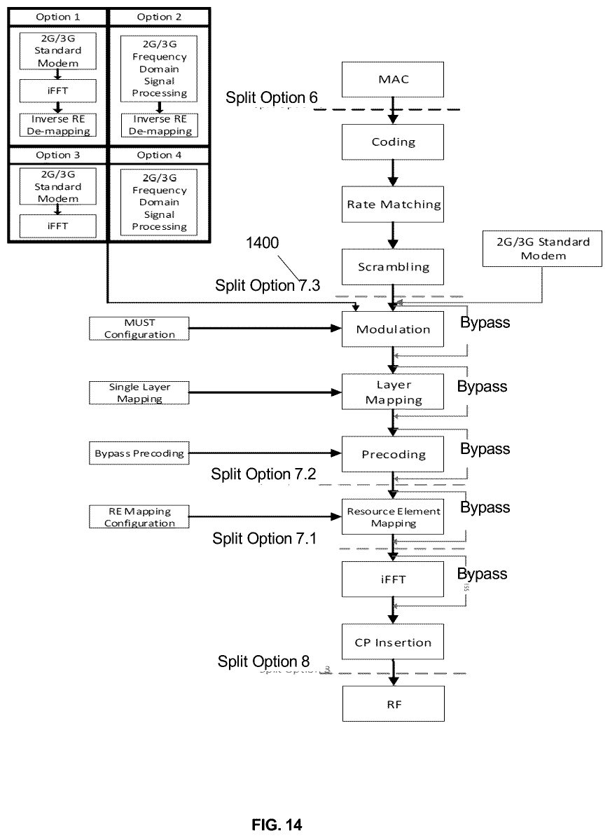

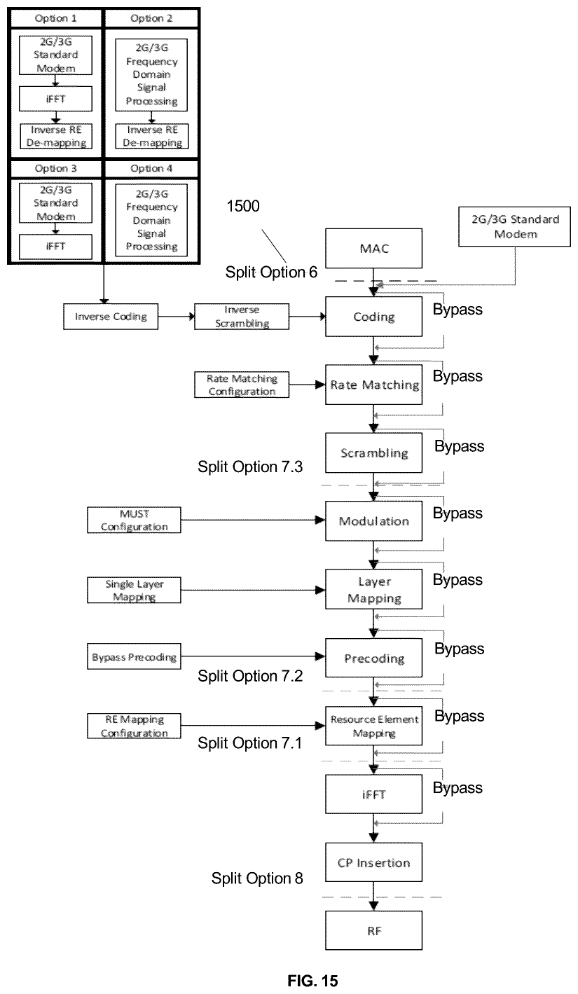

A sync mechanism is used to ensure that UL will arrive after 3 time slots from DL (FIG. 5).

FIG. 5 schematically depicts the use of timing advance for both 2G and 4G, in accordance with some embodiments. When a downlink signal is sent, a propagation delay is present. The propagation delay is mitigated by the use of timing advance, such that without a timing advance, the uplink from a UE collides with the downlink from the base station. A sync mechanism is used to ensure that UL will arrive after 3 time slots from DL.

Assuming delay added by the fronthaul is fixed and no variation between the antennas, the delay should be measured in the bring up stage.

The fronthaul shall have a UL and DL Event every GSM TTI Based on platform clock and synchronized with the fronthaul, every 1 mSec (timing packet) to get the DL and UL frames for GSM. The DL time is used to get the UL time after 3 time slots:

3 time slot equivalent to=>3*TS=3*8861=26,583 samples=>assume 16 bit per symbol 53,166 bytes

The fronthaul may have the capability to move in the sample location for fine tune the delay during the integration by 8 TS and 8861 samples.

Multi sector FH Requirements

In the case that there are 3 sectors, each sector has different RRH. All 3 RRH are supported with the Same L1 application, in some embodiments.

All RRH may be synchronized over the air meaning the Frame boundary over the air will be the same.

Pcl, ppl , FH Is all under Phy application or L1_App

CPRI used as protocol.

In some embodiments, a radio head protocol such as Common Public Radio Interface (CPRI) or eCPRI could be used to transmit signals, samples, in one direction or in both directions. In some embodiments, timing synchronization signals could be transmitted over the radio head protocol.

Self-interference rejection.

In some embodiments, a radio could be configured to reject self-interference from its own signals, including rejection of self-interference caused by transmission signals in one RAT caused on another RAT, such as self-interference caused by transmitted 2G signals on 4G signals or vice versa.

This application incorporates by reference U.S. Pat. No. 11,228,475 (PWS-72590US01), in its entirety for all purposes.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to 5G-compatible networks, to LTE-compatible networks, or to networks for additional protocols that utilize radio frequency data transmission. Various components in the devices described herein may be added, removed, split across different devices, combined onto a single device, or substituted with those having the same or similar functionality.

It is noted that 5G uses similar radio frequency technology to LTE, e.g., orthogonal frequency division multiple access (OFDMA), and therefore, it is contemplated by the inventors that 5G could be intermixed with 2G in the same way described herein as for 4G, provided that intermixing of 2G and 5G samples be done with proper attention to 5G frequency numerologies and frame alignment, which are analogous to those for 4G. In some embodiments, therefore, 2G and 5G could be provided on the same carrier and output over the same antenna and provided using CPRI or eCPRI, as described herein.

Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment, limited only by the following claims.

1. A radio frequency front end (RFFE), comprising: a 2G Global System for Mobile telecommunications (GSM) transceiver; a 4G Long Term Evolution (LTE) transceiver; and a combiner coupled to the 2G GSM transceiver and to the 4G LTE transceiver and to a radio head, wherein the combiner is coupled to the radio head via at least one stream of IQ samples, the at least one stream carrying samples derived from the 2G GSM transceiver and samples derived from the 4G LTE transceiver.

2. The RFFE of claim 1, wherein the RFFE is configured to provide downlink for 2G and 4G.

3. The RFFE of claim 1, wherein the combiner is configured to upsample 2G signals from the 2G GSM transceiver to a 4G carrier frequency.

4. The RFFE of claim 1, wherein the RFFE is configured to transmit both 2G and 4G on a same frequency band.

5. The RFFE of claim 1, wherein the RFFE is configured to transmit both 2G and 4G on one or both of a 850 MHz frequency band or a 1900 MHz frequency band.

6. The RFFE of claim 1, wherein the RFFE is an uplink RFFE, and wherein the combiner provides demultiplexing of received 2G GSM signals from 2G GSM UEs and received 4G LTE signals from 4G LTE UEs, and wherein the RFFE outputs 2G GSM samples to the 2G GSM transceiver and 4G LTE samples to the 4G LTE transceiver.

7. The RFFE of claim 1, wherein the at least one stream uses one of a common public radio interface (CPRI) interface or an enhanced common public radio interface (eCPRI) interface.

8. The RFFE of claim 1, further comprising a 5G New Radio (NR) transceiver coupled to the combiner, and wherein the combiner is coupled to the radio head via at least one stream of IQ samples carrying samples derived from the 2G GSM transceiver and samples derived from the 5G NR transceiver.

9. The RFFE of claim 1, wherein the radio head outputs both 2G and 4G downlink on a single frequency carrier.

10. A method for providing 2G and 4G downlink on a single frequency carrier, comprising:
providing a 2G Global System for Mobile telecommunications (GSM) transceiver chain;
providing a 4G Long Term Evolution (LTE) transceiver chain;
intermixing samples of 2G and 4G at a digital radio frequency front end into a single intermixed sample stream;
upsampling the intermixed sample stream to a carrier frequency compatible with both 2G and 4G; and
transmitting the upsampled intermixed sample stream.

11. The method of claim 1, further comprising transmitting both 2G and 4G on a same carrier frequency.

12. The method of claim 1, further comprising using one of a common public radio interface (CPRI) interface or an enhanced common public radio interface (eCPRI) interface.
